(19) United States
(12) Patent Application Publication
(10) Pub. No.: US 2007/0294308 A1
(43) Pub. Date: Dec. 20, 2007

(54) Managing Data Retention in a Database Operated by a Database Management System

(76) Inventor: Mark G. Megerian, Rochester, MN (US)

Correspondence Address: IBM (ROC-BLF), C/O BIGGERS & OHANIAN, LLP, P.O. BOX 1469, AUSTIN, TX, 78767-1469, US

(21) Appl. No.: 11/423,634

(22) Filed: Jun. 12, 2006

(51) Int. Cl. G06F 17/30

(52) U.S. Cl. 707/200

(57) ABSTRACT

Methods, apparatus, and computer program products are disclosed for managing data retention in a database operated by a database management system (‘DBMS’) that include creating, in metadata of the database, a retention policy for data of the database, and enforcing the retention policy by the DBMS. Managing data retention in a database operated by a DBMS may also include adding to the command set a retention command capable of creating the retention policy for data of the database, and creating the retention policy by the retention command. Managing data retention in a database operated by a DBMS may also include adding the retention measurement column to a table of the database. Managing data retention in a database operated by a DBMS may also include periodically enforcing the retention policy according to the retention periods.

### BACKGROUND OF THE INVENTION

1. Field of the Invention

The field of the invention is data processing, or, more specifically, methods, apparatus, and computer program products for managing data retention in a database operated by a database management system.

2. Description Of Related Art

The development of the EDVAC computer system of 1948 is often cited as the beginning of the computer era. Since that time, computer systems have evolved into extremely complicated devices. Today's computers are much more sophisticated than early systems such as the EDVAC. The most basic requirements levied upon computer systems, however, remain little changed. A computer system's job is to access, manipulate, and store information. Computer system designers are constantly striving to improve the way in which a computer system can deal with information.

Information stored on a computer system is often organized in a structure called a database. A database is a collection of related data and metadata. Metadata is data that describes other data such as, for example, data statistics. The data of a database is typically grouped into related structures called ‘tables,’ which in turn are organized in rows of individual data elements. The rows are often referred to a ‘records,’ and the individual data elements are referred to as ‘fields’ or ‘columns.’ In this specification generally, therefore, an aggregation of fields is referred to as a ‘record’ or a ‘data structure,’ and an aggregation of records is referred to as a ‘table.’

The metadata of a database typically includes schemas, table indexes, and database statistics. A schema is a structural description of the data in the database. A schema typically defines the columns of a table, the data types of the data contained in each column, which columns to include in an index, and so on. An index is a database structure used to optimize access to the rows in a table. An index is typically smaller than a table because an index is created using one or more columns of the table, and an index is optimized for quick searching, usually via a balanced tree. Database statistics describe the data in tables of a database. Database statistics may describe, for example, the number of records having a particular value for a particular field. As with the data of a database, metadata is often stored in tables of the database.

A computer system typically operates according to computer program instructions in computer programs. A computer program that supports access to information in a database is typically called a database management system or a ‘DBMS.’ A DBMS is computer software that is responsible for helping other computer programs access, manipulate, and save information in a database. A DBMS often utilizes metadata of the database for accessing and manipulating data of the database.

A DBMS typically supports access and management tools to aid users, developers, and other programs in accessing information in a database. One such tool is the structured query language (‘SQL’). SQL is query language for requesting information from a database. Although there is a standard of the American National Standards Institute (‘ANSI’) for SQL, as a practical matter, most versions of SQL tend to include many extensions. Here is an example of a database query expressed in SQL:

select * from stores, transactions
where stores.location = “Rochester”
and stores.storeID = transactions.storeID

This SQL query accesses information in a database by selecting records from two tables of the database, one table named ‘stores’ and another table named ‘transactions.’ The records selected are those having value ‘Rochester’ in their store location field and transactions for the stores in Rochester. To retrieve the result for this SQL query, the DBMS generates a number of ‘primitive queries,’ each primitive query used to retrieve a portion of the data needed to satisfy the SQL query. In retrieving the data for this SQL query, an SQL engine will first use a primitive query generated by the DBMS to retrieve records from the stores table and then use another primitive query to retrieve records from the transaction table. Records that satisfy the primitive query requirements then are merged in a ‘join’ and returned as a result of the SQL query received by the DBMS.

As the amount of data stored in a database grows, often the performance of database queries begins to suffer. Larger quantities of data contained in a database typically translate into longer query times and slower database performance. The accumulation of data in a database may result in files becoming so large that the performance of business critical applications and employee productivity begins to suffer.

To maintain database performance at an acceptable level, administrators periodically move or delete stale data from the database according to a data retention policy. A business typically establishes a data retention policy to specify how long data remains in the business's live, production database before the data become stale, that is, before the data becomes irrelevant or rarely accessed. Many businesses implement data retention policies using nightly batch programs, cron jobs, and other ad hoc solutions. Such implementations are often cumbersome and error-prone because these implementations typically require a deep understanding of the operating system on which the implementations run. These implementations also tend to require that the system administrator and the database administrator be the same person, or at the very least, that the system administrator and the database administrator work closely together. The large size of many organizations, however, often prohibits such a working arrangement.

### SUMMARY OF THE INVENTION

Methods, apparatus, and computer program products are disclosed for managing data retention in a database operated by a database management system (‘DBMS’) that include creating, in metadata of the database, a retention policy for data of the database, and enforcing the retention policy by the DBMS. Managing data retention in a database operated by a DBMS may also include adding to the command set a retention command capable of creating the retention policy for data of the database, and creating the retention policy by the retention command. Managing data retention in a database operated by a DBMS may also include adding the retention measurement column to a table of the database. Managing data retention in a database operated by a DBMS may also include periodically enforcing the retention policy according to the retention periods. Managing data retention in a database operated by a DBMS may also include moving to a side table data subject to the retention policy. Managing data retention in a database operated by a DBMS may also include deleting data subject to the retention policy.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of an exemplary system for managing data retention in a database operated by a database management system according to embodiments of the present invention.

FIG. 2 sets forth a block diagram of automated computing machinery comprising an exemplary computer useful in managing data retention in a database operated by a database management system according to embodiments of the present invention.

FIG. 3 sets forth a flow chart illustrating an exemplary method for managing data retention in a database operated by a database management system according to embodiments of the present invention.

FIG. 4 sets forth a flow chart illustrating a further exemplary method for managing data retention in a database operated by a database management system according to embodiments of the present invention.

FIG. 5 sets forth a flow chart illustrating a further exemplary method for managing data retention in a database operated by a database management system according to embodiments of the present invention.

FIG. 6 sets forth a flow chart illustrating a further exemplary method for managing data retention in a database operated by a database management system according to embodiments of the present invention.

### DETAILED DESCRIPTION OF EXEMPLARY EMBODIMENTS

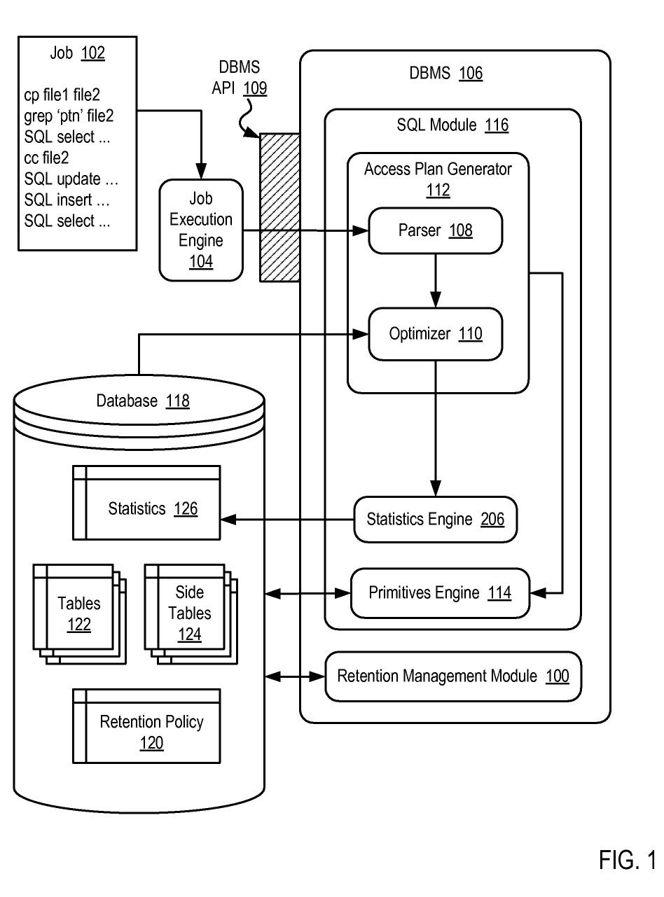

Exemplary methods, apparatus, and products for managing data retention in a database operated by a database management system according to embodiments of the present invention are described with reference to the accompanying drawings, beginning with FIG. 1. FIG. 1 sets forth a block diagram of an exemplary system for managing data retention in a database operated by a database management system according to embodiments of the present invention. The system of FIG. 1 operates generally for managing data retention in a database operated by a database management system according to embodiments of the present invention by creating, in metadata of the database, a retention policy for data of the database, and enforcing the retention policy by the DBMS.

The exemplary system of FIG. 1 includes a database (118). The database (118) stores data in tables (122). The database (118) of FIG. 1 also includes a retention policy (120). A retention policy is a set of rules governing the retention of data in a database. A retention policy may, for example, include metadata specifying data of the database that is subject to the policy, a retention period for data subject to the policy, and an enforcement frequency for data subject to the policy. An exemplary retention policy, therefore, may specify for example that all data over three months old is to be deleted or moved into a side table once a week. In the example of FIG. 1, the retention policy (120) is implemented as a table of metadata in the database (118) that represents a retention policy for the database (118).

In the exemplary system of FIG. 1, the database (118) also includes side tables (124). Side tables (124) are tables of a database into which data is moved from the tables (122) of the database (118) typically used by the DBMS to satisfy queries from client applications. As data in the tables (122) becomes less relevant or infrequently accessed, the data from the tables (122) is either deleted or moved into the side tables (124). Side tables (124), therefore, serve as containers for less relevant or infrequently accessed data.

The exemplary system of FIG. 1 includes a DBMS (106) to provide access tools and management tools to aid users, developers, and other programs in accessing the data stored in tables (122) of the database (118). Access and management tools provided by DBMS (106) may be implemented as software modules inside the DBMS. In the exemplary system of FIG. 1, DBMS (106) includes a SQL module (116). SQL module (116) is implemented as computer program instructions that execute a SQL query against the tables (122) of database (118).

In the exemplary system of FIG. 1, SQL module (116) receives SQL queries for execution from job execution engine (104). Job execution engine (104) is a software module that executes jobs, such as job (102), by passing commands from the jobs to software applications appropriate to the command. Jobs may mingle SQL queries with other commands to perform various data processing tasks. Job (102), for example, includes several commands for execution as part of job (102), including:
“cp filet file2,” an operating system command to copy one file to another file,
“grep ‘ptn’ file2,” a general regular expression command of the operating system to find occurrences of ‘ptn’ in file ‘file2’,
“cc file2,” a command to compile file ‘file2’ as a C program, and
several SQL commands, each of which passes call parameters identifying a SQL query to an executable command identified as ‘SQL.’

In this example, job execution engine (104) will pass the operating system commands from job (102) to an operating system for execution and pass the SQL queries from job (102) to SQL module (116) for execution. Job execution engine (104) passes the SQL queries to SQL module (116) through an application programming interface (‘API’) (109) of database management system (‘DBMS’) (106). DBMS (106) exposes DBMS API (109) to enable applications, such as, for example, job execution engine (104), to access modules of the DBMS, such as, for example, SQL module (116). The DBMS API (109) provides a command set for administering the DBMS (106). The ‘SQL’ command illustrated in job (102) is an exemplary command in the command set exposed through DBMS API (109).

In the exemplary system of FIG. 1, SQL module (116) includes access plan generator (112). An access plan is a sequence of database operations for carrying out a query to the database. The access plan generator (112) of FIG. 1 is implemented as computer program instructions that create an access plan for a SQL query. An access plan is a description of database functions for execution of an SQL query. Taking the following SQL query as an example:

select * from stores, transactions
where stores.storeID = transactions.storeID,

access plan generator (112) may generate the following exemplary access plan for the exemplary SQL query above:

tablescan stores
join to
index access of transactions

This access plan represents database functions that are carried out by primitive queries to the database. In the example above, the DBMS uses primitive queries to scan through the stores table and, for each stores record, join all transactions records for the store. The transactions for a store in the transaction table are identified through the ‘storeID’ field serving as a foreign key. The fact that a selection of transactions records is carried out for each store record in the stores table identifies the join function as iterative.

The exemplary access plan generator (112) of FIG. 1 includes a parser (108) for parsing the SQL query. Parser (108) is implemented as computer program instructions that parse the SQL query. A SQL query is presented to SQL module (116) in text form as the parameters of a SQL command. Parser (108) retrieves the elements of the SQL query from the text form of the query and places them in a data structure more useful for data processing of a SQL query by SQL module (116).

In the exemplary system of FIG. 1, access plan generator (112) also includes an optimizer (110) implemented as computer program instructions that optimize the access plan in dependence upon database management statistics (126). Database statistics may reveal, for example, that there are only two values for ‘storeID’ in the transactions table—so that it is more efficient to scan the transactions table rather than using an index to locate records with a particular value for ‘storeID.’ Alternatively, database statistics may reveal that there are many transaction records with only a few transactions records for each value for ‘storeID’—so that it is more efficient to access the transactions records by an index.

Database statistics are typically implemented as metadata of a particular database table, such as, for example, metadata of tables (122) of database (118). Database statistics (126) may include, for example:
Histogram statistics: a histogram range and a count of values in the range,
Frequency statistics: a frequency of occurrence of a value in a column, and
Cardinality statistics: a count of the number of different values in a column.

These three database statistics are presented for explanation only, not for limitation. The use of any database statistics as will occur to those of skill in the art is well within the scope of the present invention. When the optimizer attempts to use databases statistics for a column of a table, for example, and finds the database statistics missing or stale, the optimizer (110) notifies statistics engine (206). Statistics engine (206) then generates the missing or stale statistics.

In the exemplary system of FIG. 1, the exemplary SQL module (116) includes a primitives engine (114) implemented as computer program instructions that execute primitive query functions in dependence upon the access plan. A ‘primitive query function,’ or simply a ‘primitive,’ is a software function that carries out actual operations on a database, retrieving records from tables, inserting records into tables, deleting records from tables, updating records in tables, and so on. Primitives correspond to parts of an access plan and are identified in the access plan. Examples of primitives include the following database instructions:
retrieve the next three records from the stores table into hash table H1,
retrieve one record from the transactions table into hash table H2,
join the results of the previous two operations,
store the result of the join in table T1.

In addition to the SQL module (116), the exemplary DBMS of FIG. 1 also includes retention management module (100), a set of computer program instructions improved for managing data retention in a database operated by a database management system according to embodiments of the present invention. The retention management module (100) operates generally for managing data retention in a database operated by a database management system according to embodiments of the present invention by creating, in metadata of the database, a retention policy for data of the database and enforcing the retention policy. A computer processor may, for example, execute the retention management module (100) in a main execution loop of the DBMS (106). Executing the retention management module (100) in such a manner allows the retention management module (100) to periodically enforce the retention policy (120) of the database (118).

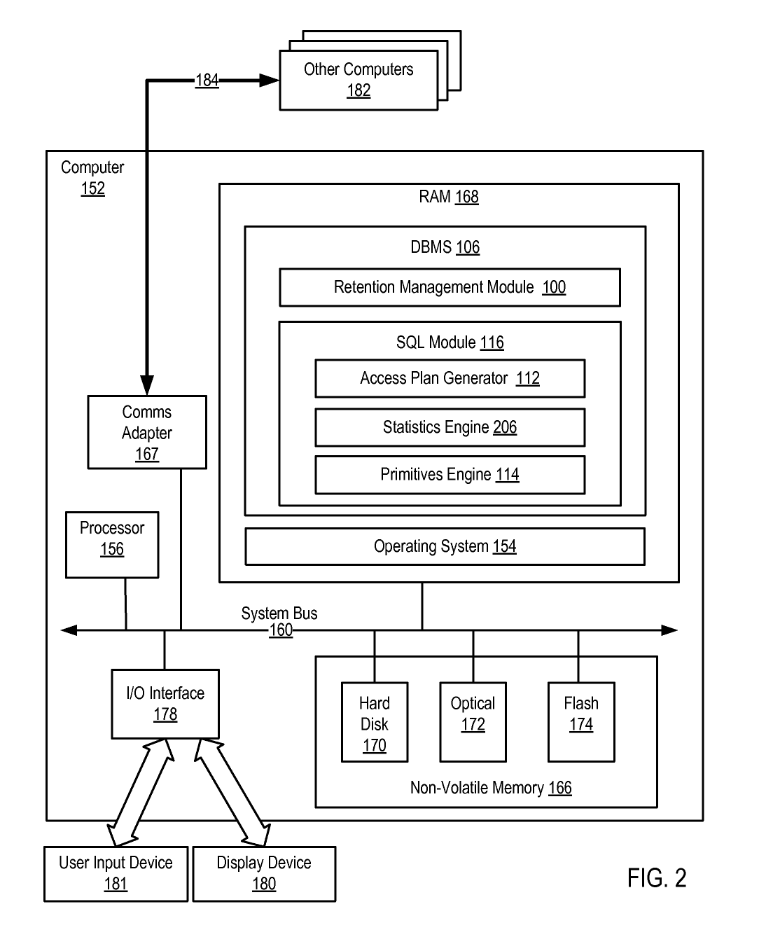

Managing data retention in a database operated by a database management system in accordance with the present invention is generally implemented with computers, that is, with automated computing machinery. All the components in the exemplary system of FIG. 1, for example, are implemented to some extent at least with computers. For further explanation, therefore, FIG. 2 sets forth a block diagram of automated computing machinery comprising an exemplary computer (152) useful in managing data retention in a database operated by a database management system according to embodiments of the present invention. The computer (152) of FIG. 2 includes at least one computer processor (156) or ‘CPU’ as well as random access memory (168) (‘RAM’) which is connected through a system bus (160) to processor (156) and to other components of the computer.

Stored in RAM (168) is DBMS (106), computer program instructions for database management. The DBMS (106) of FIG. 2 includes an SQL module (116), which in turn includes an access plan generator (112), a statistics engine (206), and a primitives engine (114), each of which implement computer program instructions stored in RAM (168) that operate computer (152) as described above. The DBMS (106) of FIG. 2 also includes a retention management module (100). The retention management module (100) is a set of computer program instructions, a module of the DBMS, configured for managing data retention in a database operated by a database management system according to embodiments of the present invention by creating, in metadata of the database, a retention policy for data of the database, and enforcing the retention policy.

Also stored in RAM (168) is an operating system (154). Operating systems useful in computers according to embodiments of the present invention include UNIX™, Linux™, Microsoft XP™, AIX™, IBM's i5/OS™, and others as will occur to those of skill in the art. The operating system (154), the DBMS (106), and the retention management module (100) in the example of FIG. 2 are shown in RAM (168), but many components of such software typically are stored in non-volatile memory (166) also.

Computer (152) of FIG. 2 includes non-volatile computer memory (166) coupled through a system bus (160) to processor (156) and to other components of the computer (152). Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The example computer of FIG. 2 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

The exemplary computer (152) of FIG. 2 includes a communications adapter (167) for implementing data communications (184) with other computers (182). Such data communications may be carried out serially through RS-232 connections, through external buses such as USB, through data communications networks such as IP networks, and in other ways as will occur to those of skill in the art. Communications adapters implement the hardware level of data communications through which one computer sends data communications to another computer, directly or through a network. Examples of communications adapters useful for managing data retention in a database operated by a database management system according to embodiments of the present invention include modems for wired dial-up communications, Ethernet (IEEE 802.3) adapters for wired network communications, and 802.11b adapters for wireless network communications.

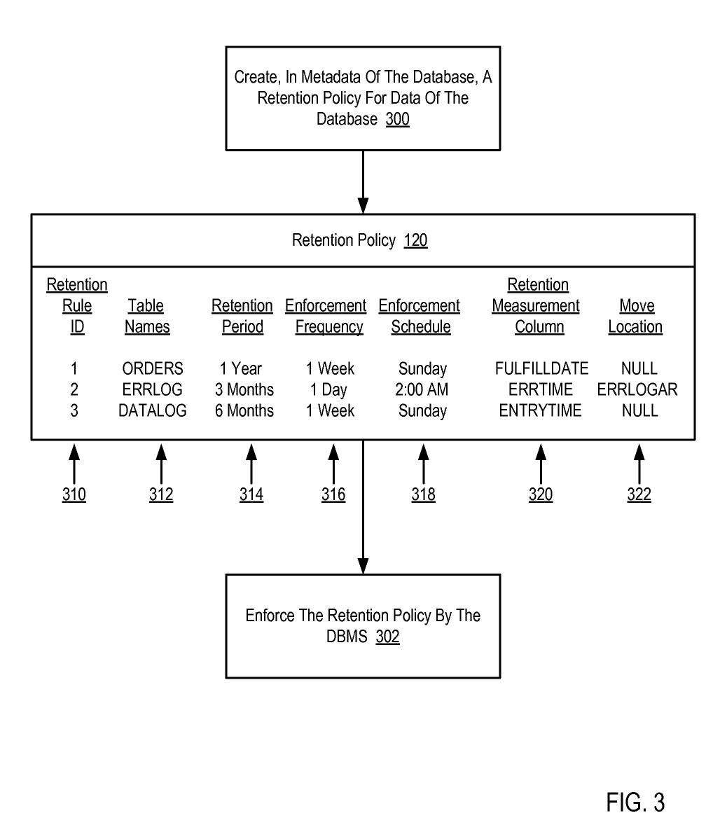

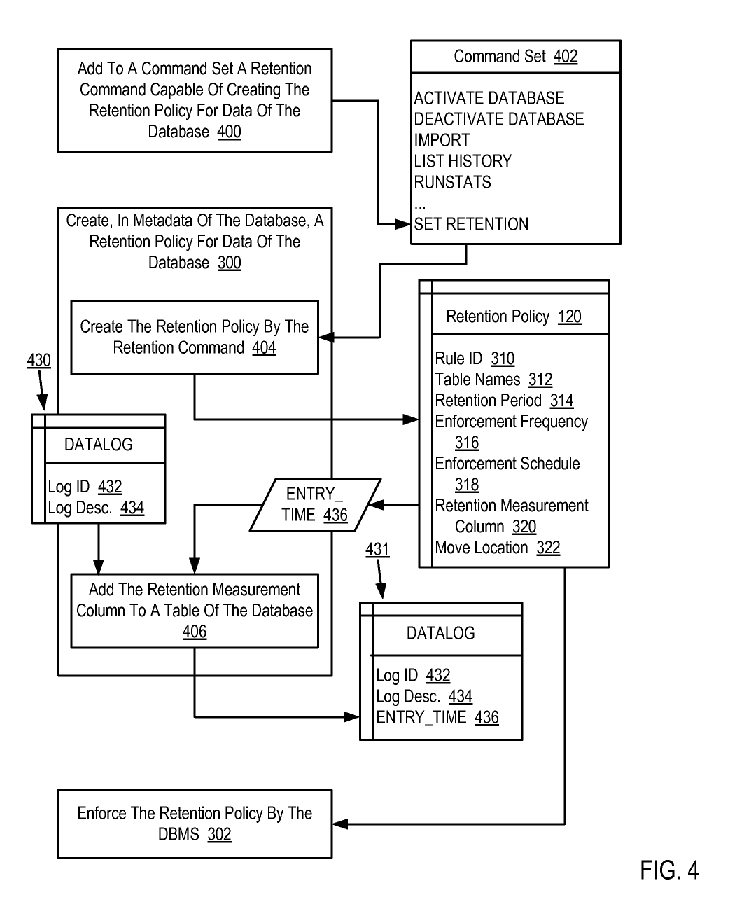

For further explanation, FIG. 3 sets forth a flow chart illustrating an exemplary method for managing data retention in a database operated by a database management system according to embodiments of the present invention. The method of FIG. 3 includes creating (300), in metadata of the database, a retention policy for data of the database. In the method of FIG. 3, creating (300), in metadata of the database, a retention policy for data of the database may be carried out by creating the retention policy by a retention command as discussed below with reference to FIG. 4.

The example of FIG. 3 includes a retention policy (120) implemented as a table of metadata that represents various rules for governing the retention of data in the database. The retention policy (120) of FIG. 3 includes metadata specifying data of a database that is subject to the policy, a retention period for data subject to the policy, and an enforcement frequency for data subject to the policy. The retention policy (120) of FIG. 3 associates a retention rule identifier (310) with table names (312), a retention period (314), an enforcement frequency (316), an enforcement schedule (318), a retention measurement column (320), and a move location (322). Each row in the retention policy (120) represents a rule of a retention policy governing retention of data in a database. The retention rule identifier (310) column contains a unique identifier for each rule of the policy. The table names column (312) specifies data subject to a rule of the policy (120), typically by table name. The retention period (314) represents the length of time that specified data is to be retained in the database. The enforcement frequency (316) represents the time period between enforcements by the DBMS of a retention rule of the retention policy. The enforcement schedule (318) specifies a point in time from which a retention period is measured. The retention measurement column (320) is used to measure the length of time that data has been stored in the table. The move location (322) identifies a side table into which data that is subject to a rule of the policy is to be moved. A NULL value for move location (322) indicates that the DBMS should delete data subject to a rule rather than move the data to a side table. The value stored in the move location (322), therefore, specifies whether data subject to the policy, upon enforcement of the retention policy, is to be moved to a side table or deleted.

In the example of FIG. 3, the retention policy (120) includes a set of three exemplary retention rules. The retention rule identified by a value of ‘1’ for the identifier (310) specifies that rows of data in the ‘ORDERS’ table should be deleted when the value for the ‘FULFILLDATE’ is one year prior to the current date. The retention rule identified by a value of ‘1’ for the identifier (310) further specifies that the retention rule of the retention policy (120) should be enforced every week on Sunday. The retention rule identified by a value of ‘2’ for the identifier (310) specifies that rows of data in the ‘ERRLOG’ table should be moved to the ‘ERRLOGAR’ table when the value for the ‘ERRTIME’ is three months prior to the current time. The retention rule identified by a value of ‘2’ for the identifier (310) further specifies that the retention rule of the retention policy (120) should be enforced every day at 2:00 a.m. The retention rule identified by a value of ‘3’ for the identifier (310) specifies that rows of data in the ‘DATALOG’ table should be deleted when the value for the ‘ENTRYTIME’ is six months prior to the current time. The retention rule identified by a value of ‘3’ for the identifier (310) further specifies that the retention rule of the retention policy (120) should be enforced every week on Sunday.

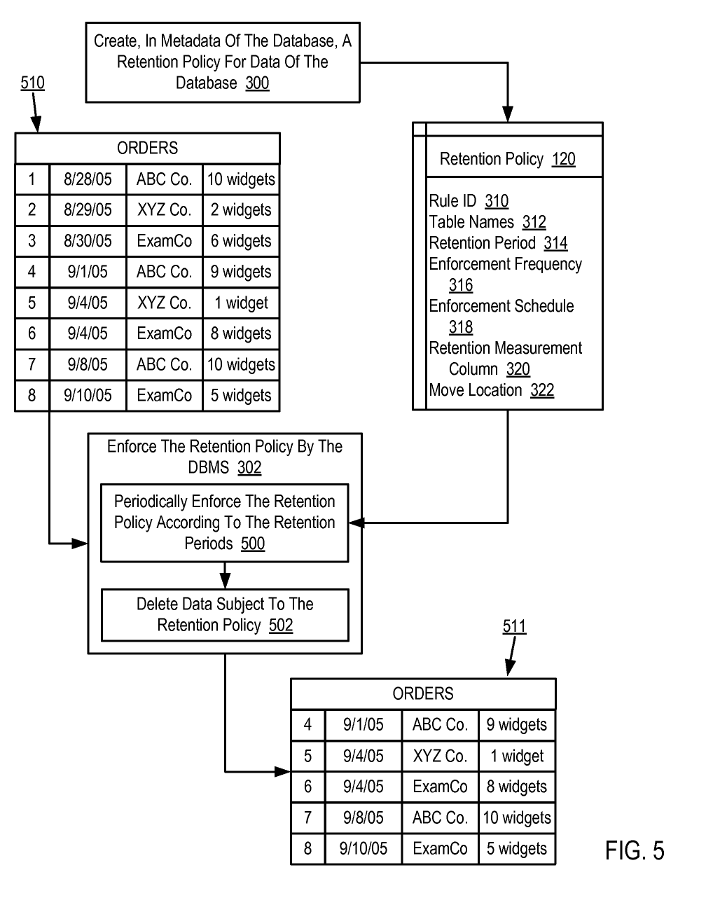

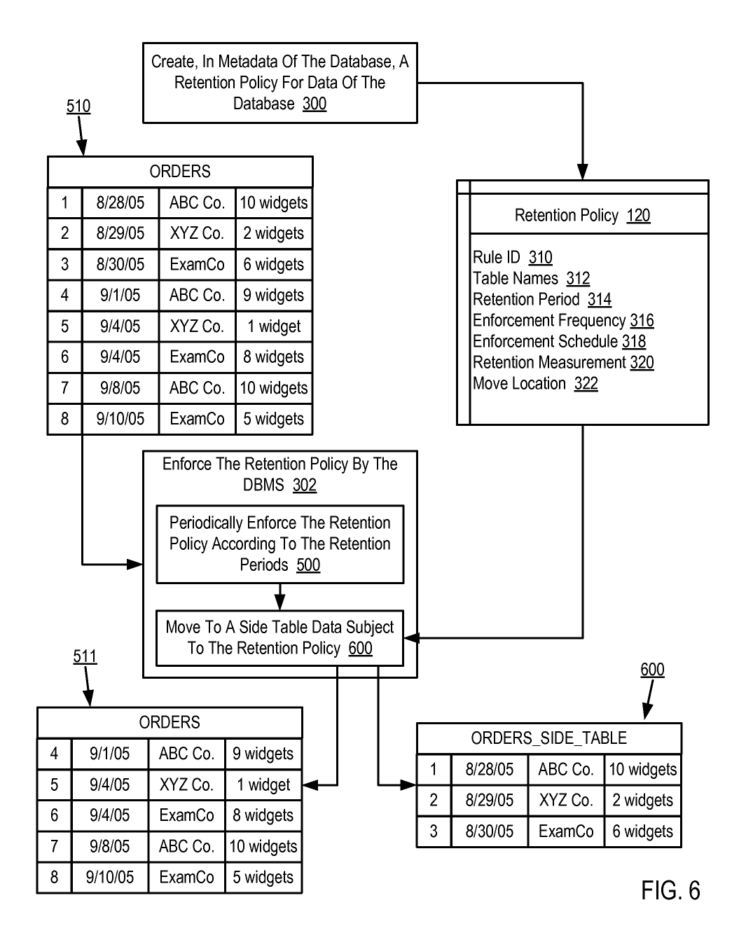

The method of FIG. 3 also includes enforcing (302) the retention policy (120) by the DBMS. Enforcing (302) the retention policy (120) by the DBMS may be carried out by periodically enforcing the retention policy according to the retention periods, deleting data subject to the retention policy, and moving to a side table data subject to the retention policy as discussed below with reference to FIGS. 5 and 6.

As mentioned above, creating, in metadata of the database, a retention policy for data of the database may be carried out by creating the retention policy by a retention command. For further explanation, therefore, FIG. 4 sets forth a flow chart illustrating a further exemplary method for managing data retention in a database operated by a database management system according to embodiments of the present invention that includes creating (404) the retention policy by the retention command.

In the example of FIG. 4, the DBMS operating a database is administered by a database administrator using a command set (402). The database administrator may be a person typing commands into a command line interface of the DBMS or a software application passing commands to the DBMS through a DBMS API. The command set (402) in the example of FIG. 4 includes several exemplary commands such as:
‘ACTIVATE DATABASE’ that activates a specified database and starts up all necessary database services, so that the database is available for connection and use by any application,
‘DEACTIVATE DATABASE’ that stops a specified database,
‘IMPORT’ that inserts data from an external file with a supported file format into a table,
‘LIST HISTORY’ that lists entries in the history file, which contains a record of recovery and administrative events,
‘RUNSTATS’ that updates statistics about the physical characteristics of a table and the associated indexes that an optimizer may use when determining access paths to the data.

The method of FIG. 4 includes adding (400) to the command set a retention command capable of creating the retention policy for data of the database. The examples below are based on a newly added DBMS command named ‘SET RETENTION.’ Readers will recognize that the ‘SET RETENTION’ command name is only one example of a command name for setting retention policies and that the new command may have any name as may occur to those of skill in the art.

Exemplary retention commands capable of creating the rules depicted in the retention policy (120) of FIG. 3 may include:
SET RETENTION ON ORDERS TO 1 YEAR FREQUENCY 1 WEEK, DAY SUNDAY, COLUMN FULFILLDATE,

This first exemplary retention command is capable of creating a retention policy that specifies that rows of data in the ‘ORDERS’ table should be deleted when the value for the ‘FULFILLDATE’ is one year prior to the current date. The first exemplary retention command above further specifies that the retention policy should be enforced every week on Sunday.

Exemplary retention commands capable of creating the rules depicted in the retention policy (120) of FIG. 3 also may include:
SET RETENTION ON ERRLOG TO 3 MONTHS FREQUENCY 1 DAY, TIME 02:00:00, COLUMN ERRTIME, BACKUP TABLE ERRLOGAR

This second exemplary retention command is capable of creating a retention policy that specifies that rows of data in the ‘ERRLOG’ table should be moved to the ‘ERRLOGAR’ table when the value for the ‘ERRTIME’ is three months prior to the current time. The second exemplary retention command above further specifies that the retention policy should be enforced every day at 2:00 a.m.

Exemplary retention commands capable of creating the rules depicted in the retention policy (120) of FIG. 3 also may include:
SET RETENTION ON DATALOG TO 6 MONTHS FREQUENCY 1 WEEK, DAY SUNDAY, COLUMN ENTRYTIME.

This third exemplary retention command is capable of creating a retention policy that specifies that rows of data in the ‘DATALOG’ table should be deleted when the value for the ‘ENTRYTIME’ is six months prior to the current time. The third exemplary retention command above further specifies that the retention policy should be enforced every week on Sunday.

Continuing with the method of FIG. 4, the method of FIG. 4 operates in a manner similar to the method of FIG. 3 in that the method of FIG. 4 includes creating (300), in metadata of the database, a retention policy for data of the database, and enforcing (302) the retention policy by the DBMS. The example of FIG. 4 is also similar to the example of FIG. 3 in that the example of FIG. 4 also includes a retention policy (120) that associates a retention rule identifier (310) with table names (312), a retention period (314), an enforcement frequency (316), an enforcement schedule (318), a retention measurement column (320), and a move location (322).

In the method of FIG. 4, creating (300), in metadata of the database, a retention policy for data of the database includes creating (404) the retention policy by the retention command. Creating (404) the retention policy by the retention command may be carried out by receiving in the DBMS the retention command, parsing the retention command for retention parameters, and storing those retention parameters in the retention policy table (120) of the database. Retention parameters are the parameters received by a DBMS along with a retention command. Examples of retention parameters from an exemplary retention command such as, for example, ‘SET RETENTION ON ORDERS TO 1 YEAR FREQUENCY 1 WEEK, DAY SUNDAY, COLUMN FULFILLDATE’ may include ‘ON ORDERS,’ ‘TO 1 YEAR,’ ‘FREQUENCY 1 WEEK,’ ‘DAY SUNDAY,’ and ‘COLUMN FULFILLDATE.’

Readers will note that not all tables of the database may have a time or date column useful for measuring the retention period. Consider, for example, the DATALOG table (430) that associates a log identifier (432) and a log description (434). Neither the log identifier (432) nor the log description (434) of the DATALOG table (430) stores a time or date useful for measuring a retention period specified in a retention policy. A retention command may, therefore, include the capability of adding to a table of the database a retention measurement column. Consider the following exemplary retention command:
SET RETENTION ON DATALOG TO 6 MONTHS FREQUENCY 1 WEEK, DAY SUNDAY, ADD COLUMN ENTRYTIME.

In the exemplary retention command above, the retention parameter ‘ADD COLUMN ENTRYTIME’ adds the capability adding ENTRY_TIME (436) as a retention measurement column to the DATALOG table (430).

Because retention commands may also have the capability of adding a retention measurement column to a table, creating (300), in metadata of the database, a retention policy for data of the database according to the method of FIG. 4, includes adding (406) the retention measurement column to a table of the database. Adding (406) the retention measurement column to a table of the database may be carried out by altering the schema of the database that defines the structure of the table. Altering the schema of the database that defines the structure of the table may be carried out using the ‘ALTER’ SQL command. Continuing with the exemplary DATALOG table (430) depicted in FIG. 4, adding an ENTRY_TIME (436) column to the DATALOG table (430) may be carried out by using the following SQL command:
ALTER TABLE DATALOG ADD COLUMN ENTRY_TIME TIMESTAMP CREATE INSERT TRIGGER ON DATALOG SET ENTRY_TIME=CURRENT TIMESTAMP.

The exemplary SQL command above adds an ENTRY_TIME (436) column to the DATALOG table (430) to result in a modified DATALOG table (431). The exemplary SQL command above adds creates an insert trigger that stores the current time into the ENTRY_TIME (436) field of each record in the modified DATALOG table (431). That is, each time a new record is inserted into the modified DATALOG table (431), the current time is inserted into the ENTRY_TIME (436) field of the record and provides the DBMS a reference point from which the retention period (314) of rule in the retention policy (120) may be measured.

As mentioned above, enforcing the retention policy by the DBMS may be carried out by periodically enforcing the retention policy according to the retention periods and deleting data subject to the retention policy. For further explanation, FIG. 5 sets forth a flow chart illustrating a further exemplary method for managing data retention in a database operated by a database management system according to embodiments of the present invention that includes periodically (500) enforcing the retention policy according to the retention periods and deleting (502) data subject to the retention policy.

The method of FIG. 5 operates in a manner similar to the method of FIG. 3 in that the method of FIG. 5 includes creating (300), in metadata of the database, a retention policy for data of the database, and enforcing (302) the retention policy by the DBMS. The example of FIG. 5 is also similar to the example of FIG. 3 in that the example of FIG. 5 also includes a retention policy (120) that associates a retention rule identifier (310) with table names (312), a retention period (314), an enforcement frequency (316), an enforcement schedule (318), a retention measurement column (320), and a move location (322).

In the example of FIG. 5, enforcing (302) the retention policy by the DBMS includes periodically (500) enforcing the retention policy according to the retention periods. Periodically (500) enforcing the retention policy according to the retention periods may be carried out by executing a set of computer program instructions for enforcing the retention policy according to the retention periods in the main execution loop of a DBMS. During each loop, periodically enforcing the retention policy according to the retention periods may be carried out by enforcing the retention policy according to the retention periods when the time period between the current time and the time specified in the enforcement schedule (318) exceeds the time period specified by the enforcement frequency (316) for any of the retention rules in the retention policy (120). Enforcing the retention policy according to the retention periods may be carried out by deleting (502) data subject to the retention policy (120) as described below.

Readers will recall from above that a NULL value stored in the move location (322) specifies that data subject to the policy (120) is to be deleted. In the example of FIG. 5, therefore, enforcing (302) the retention policy by the DBMS includes deleting (502) data subject to the retention policy. Deleting (502) data subject to the retention policy may be carried out by executing the ‘DELETE’ SQL command. Consider, for example, the exemplary ORDERS table (510) having the data depicted in FIG. 5 on Dec. 1, 2005 and a rule in the retention policy (120) specifying that orders with dates older than 3 months are to be deleted. Deleting (502) data in the ORDERS table (510) subject to the retention policy (120) may be carried out by executing the following exemplary SQL command:
DELETE FROM ORDERS WHERE DATE=BEFORE (Sep. 1, 2005)

The exemplary SQL command above traverses each record of the ORDERS table (510) and deletes the record if the date of the record contains a value before Sep. 1, 2005. Enforcing (302) the retention policy by the DBMS according to the method of FIG. 5, therefore, advantageously removes stale data from the ORDERS table as depicted by reference number (511).

As mentioned above, enforcing the retention policy by the DBMS may be carried out by periodically enforcing the retention policy according to the retention periods and moving to a side table data subject to the retention policy. For further explanation, FIG. 6 sets forth a flow chart illustrating a further exemplary method for managing data retention in a database operated by a database management system according to embodiments of the present invention that includes periodically (500) enforcing the retention policy according to the retention periods and moving (600) to a side table data subject to the retention policy.

The method of FIG. 6 operates in a manner similar to the method of FIG. 3 in that the method of FIG. 6 includes creating (300), in metadata of the database, a retention policy for data of the database, and enforcing (302) the retention policy by the DBMS. The example of FIG. 6 is also similar to the example of FIG. 3 in that the example of FIG. 6 also includes a retention policy (120) that associates a retention rule identifier (310) with table names (312), a retention period (314), an enforcement frequency (316), an enforcement schedule (318), a retention measurement column (320), and a move location (322).

In the example of FIG. 6, enforcing (302) the retention policy by the DBMS includes periodically (500) enforcing the retention policy according to the retention periods. Periodically (500) enforcing the retention policy according to the retention periods may be carried out by executing a set of computer program instructions for enforcing the retention policy according to the retention periods in the main execution loop of a DBMS. During each loop, periodically enforcing the retention policy according to the retention periods may be carried out by enforcing the retention policy according to the retention periods when the time period between the current time and the time specified in the enforcement schedule (318) exceeds the time period specified by the enforcement frequency (316) for any of the retention rules in the retention policy (120). Enforcing the retention policy according to the retention periods may be carried out by moving (600) to a side table data subject to the retention policy as described below.

Readers will recall from above that the value stored in the move location (322) specifies whether data subject to the policy (120), upon enforcement of the retention policy (120), is to be moved to a side table or deleted. NULL values indicate that the data is to be deleted, while non-NULL values indicate where the data is to be moved.

In the example of FIG. 6, therefore, enforcing (302) the retention policy by the DBMS includes moving (600) to a side table data subject to the retention policy. Moving (600) to a side table data subject to the retention policy may be carried out by copying the data subject to the retention policy into the side table and deleting the data subject to the retention policy from the original location. Copying the data subject to the retention policy into the side table and deleting the data subject to the retention policy from the original location may be carried out by using the ‘INSERT’ and ‘DELETE’ SQL commands. Consider, for example, the exemplary ORDERS table (510) having the data depicted in FIG. 6 on Dec. 1, 2005 and a rule in the retention policy (120) specifying that orders with dates older than 3 months are to be moved into the ORDER_SIDE_TABLE (600). Copying the data from the ORDERS table (510) subject to the exemplary rule in the retention policy (120) into the ORDERS_SIDE_TABLE (600) may be carried out by executing the following exemplary SQL command:
INSERT INTO ORDER_SIDE_TABLE (SELECT * FROM ORDERS WHERE DATE=BEFORE (Sep. 1, 2005))

The exemplary SQL command above traverses each record of the ORDERS table (510) and copies the record into the ORDERS_SIDE_TABLE (600) if the date of the record contains a value before Sep. 1, 2005. After copying the data from the ORDERS table (510) subject to the exemplary rule in the retention policy (120) into the ORDERS_SIDE_TABLE (600), deleting the data in the ORDERS table (510) subject to the retention policy (120) may be carried out by executing the following exemplary SQL command:
DELETE FROM ORDERS WHERE DATE=BEFORE (Sep. 1, 2005)

The exemplary SQL command above traverses each record of the ORDERS table (510) and deletes the record if the date of the record contains a value before Sep. 1, 2005. Enforcing (302) the retention policy by the DBMS according to the method of FIG. 6, therefore, advantageously removes stale data from the ORDERS as depicted by reference number (511) and stores the removed data in the ORDERS_SIDE_TABLE depicted by reference number (600).

Exemplary embodiments of the present invention are described largely in the context of a fully functional computer system for managing data retention in a database operated by a database management system. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethemets™ and networks that communicate with the Internet Protocol and the World Wide Web. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A computer-implemented method for managing data retention in a database operated by a database management system (‘DBMS’), the method comprising:
creating, in metadata of the database, a retention policy for data of the database; and
enforcing the retention policy by the DBMS.

2. The method of claim 1 wherein:
the DBMS is administered using a command set;
the method further comprises adding to the command set a retention command capable of creating the retention policy for data of the database; and
creating the retention policy further comprises creating the retention policy by the retention command.

3. The method of claim 2 wherein:
the retention command further comprises a capability of adding to a table of the database a retention measurement column; and
creating the retention policy for data of the database further comprises adding the retention measurement column to a table of the database.

4. The method of claim 1 wherein the retention policy comprises metadata of the database that specifies data subject to the policy, a retention period for data subject to the policy, and an enforcement frequency for data subject to the policy.

5. The method of claim 1 wherein:
the retention policy comprises metadata of the DBMS that specifies data subject to the policy, retention periods for data subject to the policy, and an enforcement frequency for data subject to the policy; and
enforcing the retention policy further comprises periodically enforcing the retention policy according to the retention periods.

6. The method of claim 1 wherein the retention policy comprises:
metadata of the DBMS that specifies whether data subject to the policy, upon enforcement of the retention policy, is to be moved to a side table or deleted; and
metadata of the DBMS that specifies, for data that is to be moved, where the data is to be moved.

7. The method of claim 1 wherein enforcing the retention policy further comprises moving to a side table data subject to the retention policy.

8. The method of claim 1 wherein enforcing the retention policy further comprises deleting data subject to the retention policy.

9. An apparatus for managing data retention in a database operated by a database management system (‘DBMS’), the apparatus comprising a computer processor, a computer memory operatively coupled to the computer processor, the computer memory having disposed within it computer program instructions capable of:
creating, in metadata of the database, a retention policy for data of the database; and
enforcing the retention policy by the DBMS.

10. The apparatus of claim 9 wherein:
the DBMS is administered using a command set;
the method further comprises computer program instructions capable of adding to the command set a retention command capable of creating the retention policy for data of the database; and
creating the retention policy further comprises creating the retention policy by the retention command.

11. The apparatus of claim 9 wherein the retention policy comprises metadata of the database that specifies data subject to the policy, a retention period for data subject to the policy, and an enforcement frequency for data subject to the policy.

12. The apparatus of claim 9 wherein enforcing the retention policy further comprises moving to a side table data subject to the retention policy.

13. The apparatus of claim 9 wherein enforcing the retention policy further comprises deleting data subject to the retention policy.

14. A computer program product for managing data retention in a database operated by a database management system (‘DBMS’), the computer program product disposed upon a signal bearing medium, the computer program product comprising computer program instructions capable of:
creating, in metadata of the database, a retention policy for data of the database; and
enforcing the retention policy by the DBMS.

15. The computer program product of claim 14 wherein the signal bearing medium comprises a recordable medium.

16. The computer program product of claim 14 wherein the signal bearing medium comprises a transmission medium.

17. The computer program product of claim 14 wherein:
the DBMS is administered using a command set;
the method further comprises computer program instructions capable of adding to the command set a retention command capable of creating the retention policy for data of the database; and
creating the retention policy further comprises creating the retention policy by the retention command.

18. The computer program product of claim 14 wherein the retention policy comprises metadata of the database that specifies data subject to the policy, a retention period for data subject to the policy, and an enforcement frequency for data subject to the policy.

19. The computer program product of claim 14 wherein enforcing the retention policy further comprises moving to a side table data subject to the retention policy.

20. The computer program product of claim 14 wherein enforcing the retention policy further comprises deleting data subject to the retention policy.
